(19) United States
(12) Patent Application Publication
(10) Pub. No.: US 2019/0301791 A1
(43) Pub. Date: Oct. 3, 2019

(54) POWERED SHELF FOR AN APPLIANCE

(71) Applicant: Haier US Appliance Solutions, Inc., Wilmington, DE (US)

(72) Inventors: Louis A. Wantland, Louisville, KY (US); Bagawathkumar Chellappan, Prospect, KY (US)

(21) Appl. No.: 15/939,387

(22) Filed: Mar. 29, 2018

(51) Int. Cl. F25D 27/00; F25D 25/02; H01R 31/02

(52) U.S. Cl. CPC F25D 27/00; H01R 31/02; F25D 25/02

(57) ABSTRACT

An appliance and a powered shelf therefore are provided. The powered shelf includes features that provide the powered shelf with powering and charging capabilities. In particular, the features enable the powered shelf to power or charge a removably connected electrical device that has been placed on or proximate the powered shelf.

### FIELD OF THE INVENTION

The present disclosure is related generally to refrigerator appliances, and more particularly to refrigerator appliances that include a powered shelf for powering electrical devices.

### BACKGROUND OF THE INVENTION

Certain refrigerator appliances include powered shelves that can be moved from one shelf mounting position to another within the refrigerator appliance. Such powered shelves may be mounted to one or more powered tracks so that electrical power can be provided to the shelves for shelf lighting, temperature control, and/or other desirable features.

In some instances, it is desirable to place electrical devices on the powered shelves, such as e.g., inventory management devices, food preservation devices, food mixing modules, ultraviolet light modules, etc. Such electrical devices typically are battery powered. Thus, to keep such devices charged or otherwise functioning, a user must remove the device from the appliance, charge the device, and then place the device back into the appliance. This may be an inconvenience to users.

Accordingly, appliances having powered shelves that address one or more of the challenges noted above are desirable.

### BRIEF DESCRIPTION OF THE INVENTION

Aspects and advantages of the invention will be set forth in part in the following description, or may be apparent from the description, or may be learned through practice of the invention.

In accordance with one embodiment, an appliance is provided. The appliance includes a cabinet defining a volume. The appliance includes a powered shelf in electrical communication with a power source and configured for providing electrical power to a removably connected electrical device. The powered shelf includes a frame and a power connection element in electrical communication with the power source and positioned along the frame for powering the removably connected electrical device.

In accordance with another exemplary embodiment, a powered shelf of an appliance for providing electrical power to a removably connected electrical device is provided. The powered shelf includes a shelf panel. The powered shelf also includes an electric coil attached to the shelf panel and in electrical communication with a power source, the electric coil configured to wirelessly provide electrical power to the removably connected electrical device.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of a refrigerator appliance according to an exemplary embodiment of the present subject matter;

FIG. 2 provides a front perspective view of the refrigerator appliance of FIG. 1 with a pair of refrigerator doors and a freezer door shown in an open configuration to reveal a fresh food chamber and freezer chamber of the refrigerator appliance according to an exemplary embodiment of the present subject matter;

FIG. 3 provides a front, perspective view of a powered shelf mounted to a powered track according to an exemplary embodiment of the present subject matter;

FIG. 4 provides a front, perspective view of a powered shelf mounted to a powered track according to an exemplary embodiment of the present subject matter;

FIG. 5 provides a schematic view of an exemplary electrical device powered by a powered shelf according to an exemplary embodiment of the present subject matter;

FIG. 6 provides another schematic view of an exemplary electrical device powered by a powered shelf according to an exemplary embodiment of the present subject matter;

FIG. 7 provides a front, perspective view of another exemplary powered shelf mounted to a powered track according to an exemplary embodiment of the present subject matter;

FIG. 8 provides a cross sectional view of a shelf panel of the powered shelf of FIG. 7;

FIG. 9 provides a close up, cross sectional view of another exemplary embodiment of a shelf panel according to an exemplary embodiment of the present subject matter; and

FIG. 10 provides a front perspective view of another exemplary powered shelf according to an exemplary embodiment of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used in the specification and the appended claims, the singular forms “a,” “an,” and “the” include plural referents unless the context clearly dictates otherwise. The use of the term “about” or “substantially” in conjunction with a numerical value refers to within 25% of the stated amount.

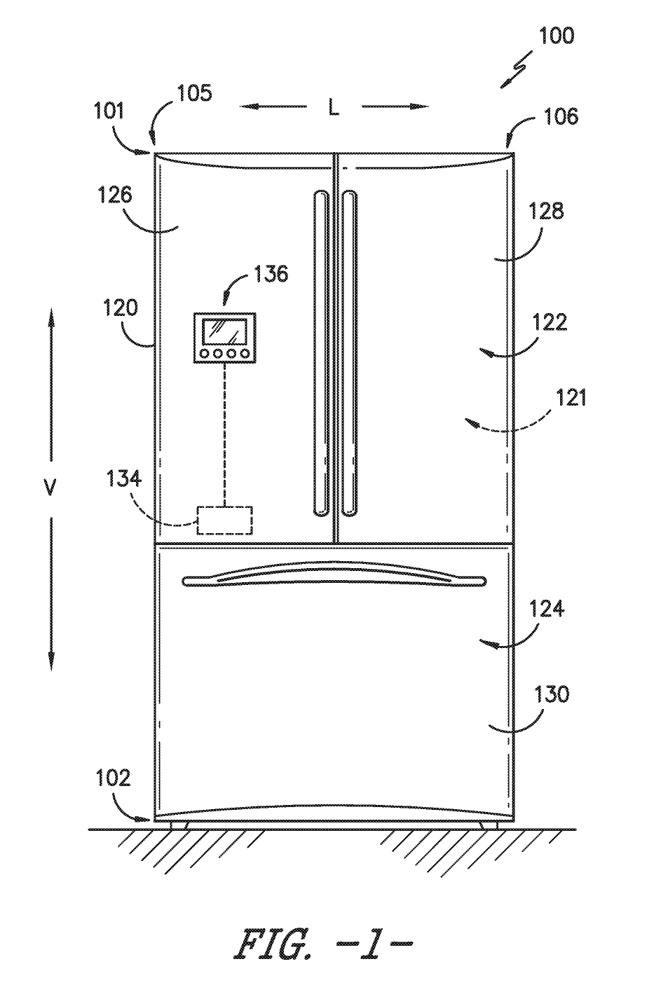

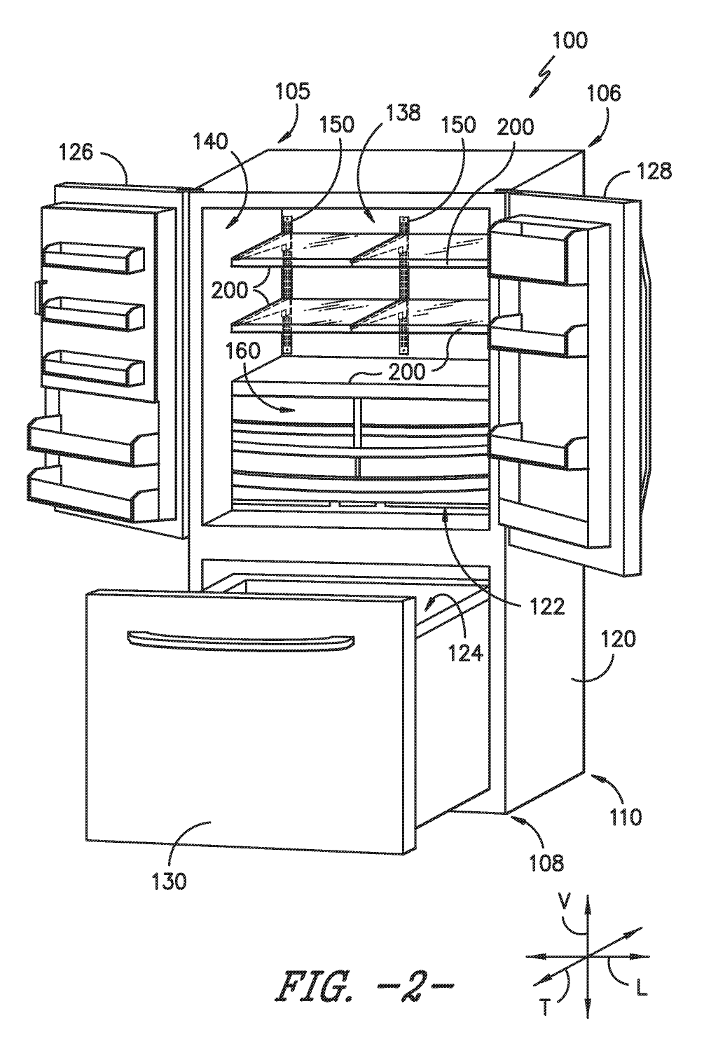

FIG. 1 provides a front view of a refrigerator appliance 100 according to an exemplary embodiment of the present subject matter. Refrigerator appliance 100 extends between a top 101 and a bottom 102 along a vertical direction V. Refrigerator appliance 100 also extends between a first side 105 and a second side 106 along a lateral direction L. A transverse direction T (FIG. 2) is defined orthogonal to the vertical and lateral directions V, L. Accordingly, vertical direction V, lateral direction L, and transverse direction T are mutually perpendicular and form an orthogonal direction system.

Refrigerator appliance 100 includes a housing or cabinet 120 defining a volume 121. Cabinet 120 also defines an upper fresh food chamber 122 and a lower freezer chamber 124 arranged below the fresh food chamber 122 along the vertical direction V. As such, refrigerator appliance 100 is generally referred to as a bottom mount refrigerator. In this exemplary embodiment, cabinet 120 also defines a mechanical compartment (not shown) for receipt of a sealed cooling system (not shown). It will be appreciated that the present subject matter can be used with other types of refrigerators (e.g., side-by-sides), freezer appliances, and/or other types of appliances more generally. Consequently, the description set forth herein is for exemplary purposes only and is not intended to limit the scope of the present subject matter in any aspect.

Refrigerator appliance 100 includes refrigerator doors 126, 128 that are rotatably hinged to an edge of cabinet 120 for accessing fresh food chamber 122. It should be noted that while doors 126, 128 are depicted in a “french door” configuration, any suitable arrangement or number of doors is within the scope and spirit of the present subject matter. A freezer door 130 is arranged below refrigerator doors 126, 128 for accessing freezer chamber 124.

Operation of refrigerator appliance 100 can be regulated by a controller 134 that is operatively coupled to a user interface panel 136. Panel 136 provides selections for user manipulation of the operation of refrigerator appliance 100 such as e.g., interior shelf lighting settings. In response to user manipulation of user interface panel 136, controller 134 operates various components of refrigerator appliance 100. Controller 134 may include a memory and one or more processors, microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor.

Controller 134 may be positioned in a variety of locations throughout refrigerator appliance 100. In the illustrated embodiment, controller 134 is located within door 126. In such an embodiment, input/output (“I/O”) signals may be routed between the controller and various operational components of refrigerator appliance 100. In one embodiment, user interface panel 136 may represent a general purpose I/O (“GPIO”) device or functional block. The user interface 136 may include input components, such as one or more of a variety of electrical, mechanical or electro-mechanical input devices including rotary dials, push buttons, and touch pads. User interface 136 may include a display component, such as a digital or analog display device designed to provide operational feedback to a user. The user interface 136 may be in communication with controller 134 via one or more signal lines or shared communication busses.

FIG. 2 provides a front, perspective view of refrigerator appliance 100 having refrigerator doors 126, 128 in an open position to reveal the interior of fresh food chamber 122. Additionally, freezer door 130 is shown in an open position to reveal the interior of freezer chamber 124. As shown, refrigerator appliance 100 extends in the transverse direction T between a front end 108 and a rear end 110.

For this exemplary embodiment, fresh food chamber 122 of refrigerator appliance 100 includes one or more powered tracks 150 mounted to a rear wall 138 of cabinet 120. Each powered track 150 is oriented along the vertical direction V and are spaced from one another, e.g., along the lateral direction L. In alternative embodiments, one or more of the powered tracks 150 may be mounted to another surface within the interior of cabinet 120, such as to one of the sidewalls 140 of cabinet 120 or in the freezer chamber 124. In addition, in some embodiments, not all of the tracks need be powered. One or more of the powered tracks 150 are in electrical communication with a power source. For instance, the power source may be a power supply isolated from the line voltage supplying power to the main loads of refrigerator appliance 100, such as the compressor, motors, etc. The power source could be a 12 volt or 24 volt power supply, for example. As another example, the power source may be a line voltage.

As depicted in FIG. 2, a number of powered shelves 200 are mounted to the powered tracks 150. For this embodiment, four (4) powered shelves 200 are mounted to powered tracks 150 within fresh food chamber 122 and are arranged in two columns and two rows as shown. The powered tracks 150 are configured to provide power to one or more of the powered shelves 200 when the powered shelves 200 are mounted thereto. One of more of the powered shelves 200 may include one or more power consuming loads. As one example, powered track 150 can deliver power to LEDs positioned on one or more of the powered shelves 200 for lighting the interior of fresh food chamber 122 when one or both of the doors 126, 128 are in the open position. As another example, in accordance with exemplary embodiments of the present subject matter, one or more of the powered shelves 200 can serve as an intermediate member or charging hub to power or charge electrical devices placed on or proximate one of powered shelves 200.

In some embodiments, one or more of the powered shelves 200 may be selectively positioned by a user in different shelf mounting positions within fresh food chamber 122. For instance, the powered shelves 200 can be moved vertically upward or downward along the vertical direction V or moved from a position proximate first side 105 to a position proximate second side 106 of refrigerator appliance 100 along the lateral direction L. Powered shelves 200 can also be removed from refrigerator appliance 100. For example, if storage room is needed for a particularly tall pot, one or more of powered shelves 200 can be removed from refrigerator appliance 100 and stowed elsewhere. Although four (4) powered shelves 200 are depicted in FIG. 2, more or less than four (4) powered shelves 200 can be provided in refrigerator appliance 100.

Further, in some embodiments, one or more powered shelves 200 may be mounted to or supported by the liner of cabinet 120 within refrigerator appliance 100. For instance, as shown in FIG. 2, the powered shelf 200 that supports a pan drawer assembly 160 positioned within fresh food chamber 122 is supported by the inner liner of cabinet 120. Accordingly, powered shelves 200 need not necessarily be powered by powered tracks 150. Power may be supplied to powered shelf 200 through the liner in any suitable manner, e.g., by a wired connection or through mating electrical contacts.

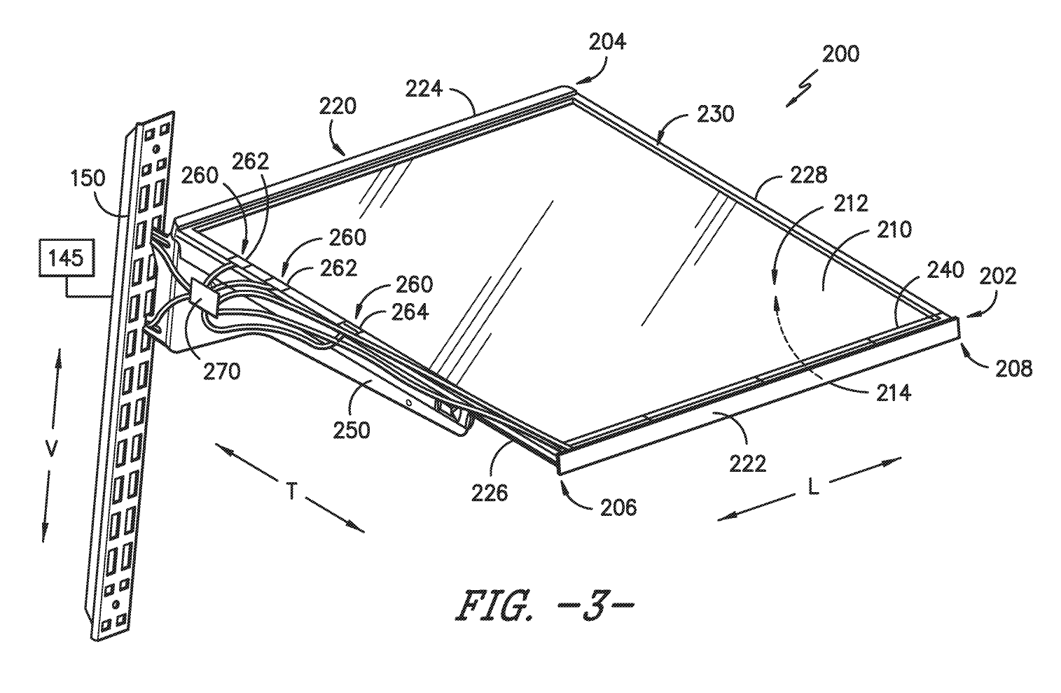

FIG. 3 provides a front, perspective view of powered shelf 200 mounted to powered track 150 according to an exemplary embodiment of the present subject matter. As depicted, powered shelf 200 extends between a front 202 and a rear 204, e.g., along the transverse direction T, and between a first side 206 and a second side 208, e.g., along the lateral direction L. Powered shelf 200 includes a shelf panel 210 having a top surface 212 and an opposing bottom surface 214. Generally, shelf panel 210 extends between front 202 and rear 204 of powered shelf 200 and between first side 206 and second side 208. For this embodiment, shelf panel 210 is formed of a tempered glass. However, shelf panel 210 may be made of any suitable material.

Powered shelf 200 also includes a frame 220 surrounding and supporting the shelf panel 210. Frame 220 includes a front member 222 and an opposing rear member 224. Front member 222 is spaced from rear member 224, e.g., along the transverse direction T. Frame 220 also includes a first side member 226 and an opposing second side member 228. First side member 226 is spaced from second side member 228, e.g., along the lateral direction L. First side member 226 and second side member 228 extend between and connect front member 222 with rear member 224. More particularly, first side member 226 extends between and connects front member 222 and rear member 224 at first side 206 of powered shelf 200 and second side member 228 extends between and connects front member 222 and rear member 224 at second side 208 of powered shelf 200. Accordingly, frame 220 extends about the perimeter of shelf panel 210. The front member 222, rear member 224, first side member 226, and second side member 228 each have a top surface 230. For this embodiment, the top surface 230 of each of the members 222, 224, 226, 228 are flush with the top surface 212 of shelf panel 210. In alternative exemplary embodiments, however, the top surface 212 of shelf panel 210 need not be flush with the top surfaces 230 of the members 222, 224, 226, 228. For instance, the top surface 230 of one or more of the members may be raised or positioned above the top surface 212 of shelf panel 210. Front, rear, and first and second side members 222, 224, 226, 228 can be made of any suitable materials, such as metal or plastic.

Front member 222, rear member 224, first side member 226, second side member 228 or a combination thereof can include a load 240 or powered feature. For example, load 240 can be LED shelf lighting as shown in FIG. 3, or additionally or alternatively, load 240 may be other features, such as temperature controls, microphones, speakers, cameras, sensors such as ethylene sniffers, load cells to weigh milk, fans, thermoelectric cells, and/or other desirable features.

Further, powered shelf 200 includes at least one bracket 250 attached to or formed integrally with frame 220 for mounting powered shelf 200 to powered track 150 in one of the shelf mounting positions. For this embodiment, powered shelf 200 includes one bracket 250 attached to first side member 226. When bracket 250 is inserted into openings of the powered track 150 to mount powered shelf 200 thereto, powered shelf 200 becomes powered by powered track 150. That is, power is transmitted from a power source 145 (shown schematically in FIG. 3) to powered track 150 and powered track 150 in turn provides electrical power to powered shelf 200. Powered shelf 200 is in electrical communication with powered track 150 when it is mounted thereto, e.g., by electrical leads. Electrical power provided to powered shelf 200 may be provided to load 240, e.g., via electrical wires as shown in FIG. 3.

In addition, with reference still to FIG. 3, electrical power provided to powered shelf 200 may be provided to one or more power connection elements 260 so that an electrical device that is removably connected with the power connection elements 260 may be powered or charged. That is, when an electrical device is in electrical communication with the powered shelf 200 via one or more of the power connection elements 260, electrical power may be provided to the electrical device. In this way, as noted previously, powered shelf 200 may serve as an intermediate member or charging hub to power or charge electrical devices placed on or positioned proximate powered shelf 200.

Such removably connected electrical devices can include any electrical or energy storage device that is not a part of powered shelf 200. For instance, the removably connected electrical device may be an inventory management device, a wine rack with inventory management sensors, an egg tray, or other “plug and play” (e.g., wired powered) or “place and play” (e.g., induction powered) electrical devices. Further, the removably connected electrical device may be an energy storage device, such as e.g., batteries.

In some embodiments, the power connection element 260 includes at least two (2) electrical contacts positioned along one of the first side member 226 and the second side member 228. For instance, for the depicted embodiment of FIG. 3, the power connection elements 260 include two (2) electrical contacts 262 positioned along first side member 226. More particularly, for this embodiment, the electrical contacts 262 are metal plates that are positioned along the top surface 230 of first side member 226. To electrically connect the removably connected electrical device to the powered shelf 200, the electrical device is positioned such that the power connection element or elements (e.g., electrical leads) of the electrical device contact the power connection elements 260 of powered shelf 200, which as noted above, are metal electrical contacts 262 in this embodiment. Notably, as the top surface 230 of first side member 226 and the top surface 212 of shelf panel 210 are flush with one another, if an electrical device placed on the powered shelf 200, the electrical device need not be tilted or positioned off balance when the electrical device is positioned to contact the power connection elements 260.

In alternative embodiments, additionally or alternatively to the power connection element 260 positioned at top surface 230 of first side member 226, the power connection element 260 of powered shelf 200 may include one or more electrical contacts 262 positioned along second side member 228, front member 222, and/or rear member 224. In some embodiments, power connection element 260 includes a plurality of electrical contacts 262. In such embodiments, for example, at least one of the plurality of electrical contacts 262 is positioned along the first side member 226, at least one of the plurality of electrical contacts 262 is positioned along the rear member 224, and at least one of the plurality of electrical contacts 262 is positioned along the second side member 228. In addition, in some embodiments, at least one of the plurality of electrical contacts 262 is positioned along front member 222.

Further, additionally or alternatively to the electrical contacts 262, in some exemplary embodiments, the power connection element 260 includes one or more Universal Serial Bus (USB) ports 264. In this way, removably connected electrical devices having USB powering and charging capability may be powered or charged by powered shelf 200. In the depicted embodiment of FIG. 3, USB port 264 is positioned along first side member 226. However, in alternative exemplary embodiments, USB port 264 may be positioned along second side member 228, front member 222, rear member 224, or a combination thereof. In some preferred embodiments, USB port 264 is positioned along front member 222 so that USB port 264 is easily accessible to a user. Moreover, in addition to supplying electrical power to an electrical device connected thereto, USB port 264 may be communicatively coupled with controller 134 (FIG. 1), and may be configured to provide data communication from the connected electrical device to controller 134 and vice versa. In this way, data from the electrical device may be routed to controller 134 and controller 134 may make operation decisions based on that data. Additionally or alternatively, the power connection elements 260 may include other suitable types of powering and charging ports.

For the depicted embodiment of FIG. 3, powered shelf 200 includes a power management device 270. Power management device 270 manages the power requirements of load 240 and any removably connected electrical devices connected to the power connection elements 260. Power management device 270 is communicatively coupled with controller 134 of refrigerator appliance 100 (FIG. 1) or to the controller of the appliance for which powered shelf 200 is used. Controller 134 and power management device 270 may work in unison to meet the power consuming needs of one or more removably connected electrical devices in electrical communication with the one or more power connection elements 260 of powered shelf 200.

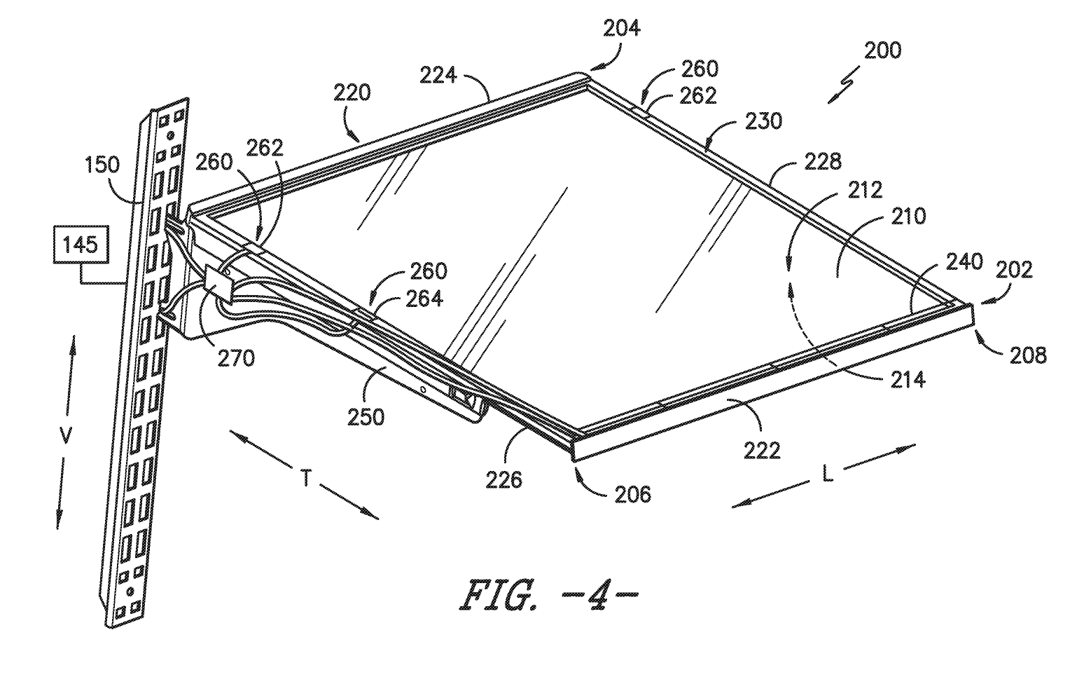

FIG. 4 provides a front, perspective view of another exemplary powered shelf mounted to a powered track according to an exemplary embodiment of the present subject matter. The exemplary powered shelf 200 of FIG. 4 is configured in a similar manner as the powered shelf of FIG. 3 and thus the same or similar reference numerals refer to the same or similar parts of powered shelf 200.

In contrast with the powered shelf of FIG. 3, the power connection elements 260 of powered shelf 200 of FIG. 4 include one electrical contact 262 positioned along first side member 226 and one electrical contact 262 along second side member 228. More particularly, one electrical contact 262 is positioned at the top surface 230 along first side member 226 and one electrical contact 262 is positioned at the top surface 230 along second side member 228. The electrical contact 262 positioned along second side member 228 may be powered by powered track 150 positioned at first side 206 of powered shelf 200 or may be powered by another powered track positioned at second side 208 of powered shelf 200 (not shown). As one electrical contact 262 is positioned along first side member 226 and one electrical contact 262 is positioned along second side member 228 large electrical devices may be powered by powered shelf 200, e.g., such as an electrical device that spans the lateral length of powered shelf 200. Examples of such electrical devices are provided below.

FIG. 5 provides a schematic view of an exemplary removably connected electrical device 300 powered by the powered shelf 200 of FIG. 4 according to an exemplary embodiment of the present subject matter. For this embodiment, the removably connected electrical device 300 is a wine rack that spans the lateral length of powered shelf 200. Electrical device 300, or wine rack in this embodiment, includes power connection elements 302. For this embodiment, the power connection elements 302 are conducting electrical contacts or leads. When electrical device 300 is positioned such that its power connection elements 302 are in contact with the power connection elements 260 of powered shelf 200, powered shelf 200 provides electrical power to electrical device 300 such that power consuming load or loads of electrical device 300 may be powered. For instance, as shown in FIG. 5, electrical device 300 includes a plurality of inventory management sensors 304 that are each associated with one of the bottle support mounts and are each powered by powered shelf 200 when electrical device 300 is mounted thereto.

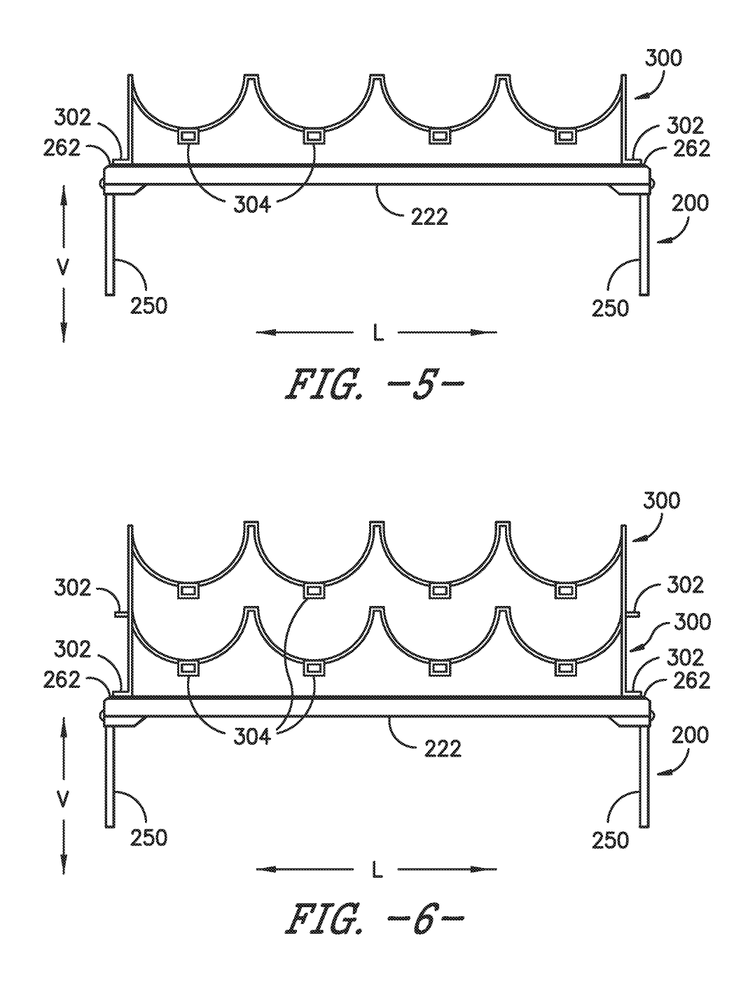

FIG. 6 provides a schematic view of a plurality of removably connected electrical devices 300 powered by powered shelf 200 according to an exemplary embodiment of the present subject matter. As shown in FIG. 6, in some embodiments, multiple removably connected devices 300 may be powered by powered shelf 200. For instance, as shown in FIG. 6, multiple removably connected electrical devices 300 may be connected to powered shelf 200 in a stacked fashion. Additionally or alternatively, one electrical device 300 may be in electrical communication with one pair of electrical contacts 262 or other power connection elements 260 of powered shelf 200 and another electrical device 300 may be in electrical communication with another pair of electrical contacts 262 or other power connection elements 260, e.g., USB port 264 (FIG. 4).

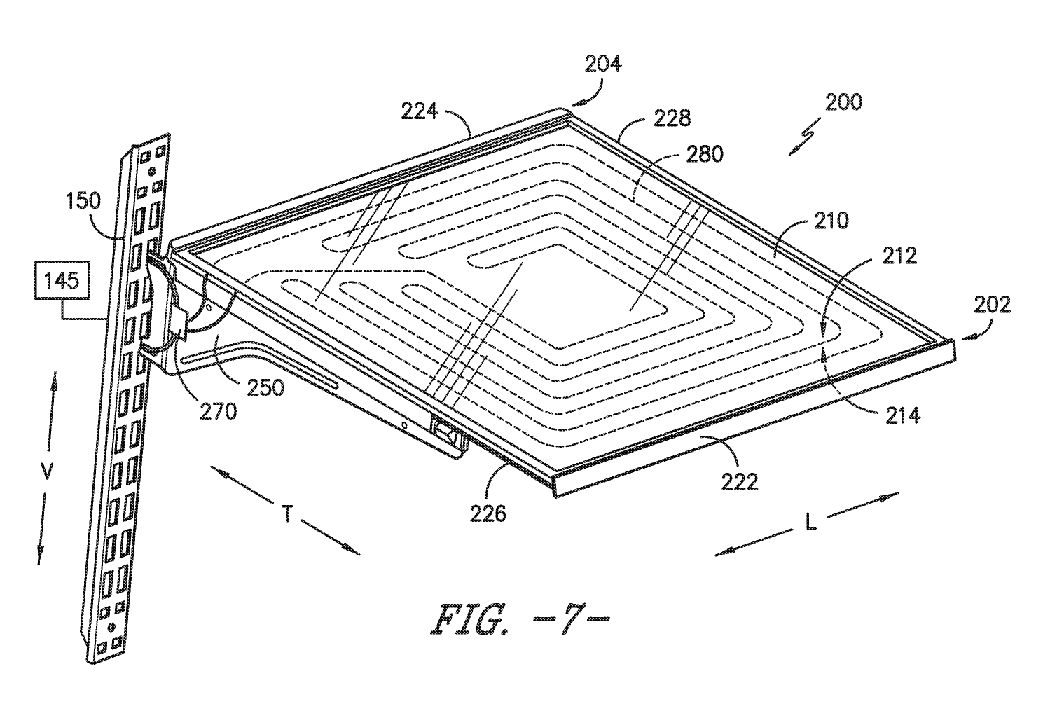

FIG. 7 provides a front, perspective view of another exemplary powered shelf according to an exemplary embodiment of the present subject matter. The exemplary powered shelf 200 of FIG. 7 includes features that are the same or similar as those of the powered shelf of FIG. 3, and thus, the same or similar reference numerals will refer to the same or similar parts of the powered shelf below.

For this exemplary embodiment, powered shelf 200 includes features that wirelessly provide electrical power to a removably connected electrical device placed on or proximate powered shelf 200, e.g., for powering or charging the device. As depicted in FIG. 7, powered shelf 200 includes an electric coil 280 that is attached to shelf panel 210. For instance, electric coil 280 may be printed on shelf panel 210, adhered to shelf panel 210, or otherwise connected to shelf panel 210. For this embodiment, electric coil 280 is printed on bottom surface 214 of shelf panel 210. In alternative exemplary embodiments, electric coil 280 is embedded within shelf panel 210. For example, electric coil 280 may be embedded within shelf panel 210 approximately midway between top surface 212 and bottom surface 214 of shelf panel 210. In this way, electric coil 280 may be protected from the elements within a chilled chamber, such as e.g., condensation and/or leaking or spilled liquids. In yet other exemplary embodiments, electric coil 280 is attached to top surface 212 of shelf panel 210.

Further, for this exemplary embodiment, shelf panel 210 defines an area, which is equal to the lateral length of shelf panel 210 multiplied by the transverse length of shelf panel 210. As shown in the depicted embodiment of FIG. 7, electric coil 280 is printed on shelf panel 210 substantially over the area of shelf panel 210. In this way, a removably connected electrical device may be powered and/or charged wirelessly by powered shelf 200 no matter where it is placed on powered shelf 200. In some alternative embodiments, electric coil 280 is printed on shelf panel 210 such that electric coil 280 extends over an area of shelf panel 210 that is less than substantially over the area of shelf panel 210. For instance, electric coil 280 may be printed over a single quadrant of the area of powered shelf 200. Thus, powered shelf 200 may have a designated powering area that is less than the total area of powered shelf 200. This may reduce the material costs of powered shelf 200, among other things.

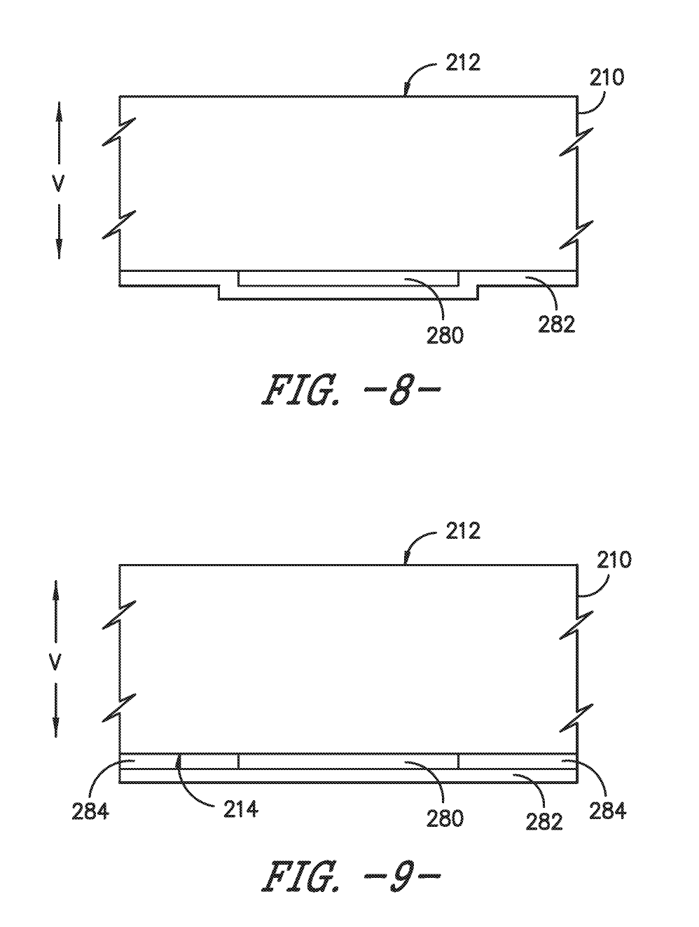

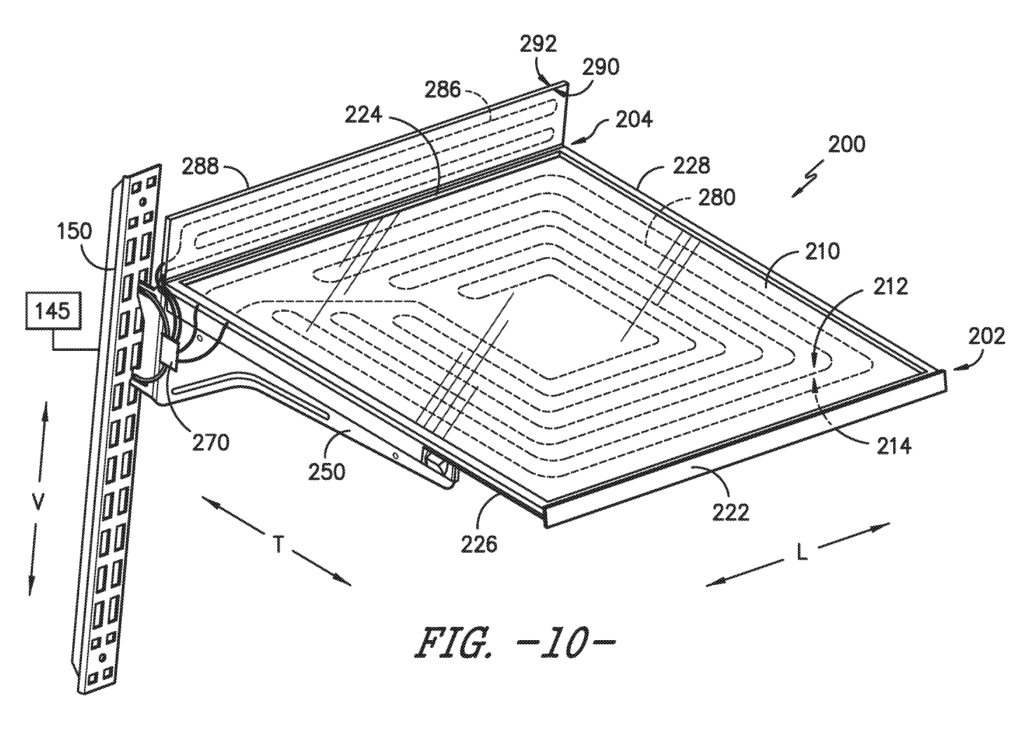

In addition, in some exemplary embodiments, powered shelf 200 includes a protective film to cover and protect electric coil 280. For instance, FIG. 8 provides a close up, cross sectional view of the shelf panel 210 of FIG. 7. As depicted in FIG. 8, electric coil 280 is attached to bottom surface 214 of shelf panel 210. A protective film 282 is attached to shelf panel 210 and in some instances to electric coil 280. Notably, electric coil 280 is disposed between protective film 282 and shelf panel 210, e.g., along the vertical direction V. Protective film 282 protects electric coil 280 from the elements, such as e.g., condensation and/or leaking or spilled liquids. Protective film 282 may be any suitable type of film. In alternative exemplary embodiments, electric coil 280 may include a corrosion resistant coating about the electrical conducting material of the coil. Further still, in some exemplary embodiments, a spacer layer may be adhered to bottom surface 214 of shelf panel 210. For instance, FIG. 9 provides a close up, cross sectional view of another exemplary embodiment of shelf panel 210. As shown, a spacer layer 284 is adhered to bottom surface 214 of shelf panel 210. In this manner, protective film 282 may be laid generally flat over the area of shelf panel 210.

Further, in some embodiments, powered shelf 200 of FIG. 7 includes one or more power connection elements in electrical communication with a power source. For instance, the power connection elements may be the power connection elements 260 of FIGS. 3 and 4 and the power source may be power source 145. The power connection elements may include, for example, at least two electrical leads 262 positioned along the frame 220 of powered shelf 200 or a USB port 264 positioned along the frame.

With reference now to FIG. 10, a front perspective view of another exemplary powered shelf 200 is provided. As shown in FIG. 10, a second electric coil 286 may additionally be attached to (e.g., printed on or adhered to) a member that extends along the vertical direction V. In particular, as depicted, powered shelf 200 defines a first direction and a second direction orthogonal to the first direction. For instance, the first direction may be a direction orthogonal to the vertical direction V (i.e., a direction along the transverse direction T or along the lateral direction L) and the second direction may be the vertical direction V. The shelf panel 210 extends between a front and a rear along the first direction, e.g., between front 202 and rear 204 along the transverse direction T. In such embodiments, rear member 224 of frame 220 attached to shelf panel 210 at rear 204 includes an extension portion 288 projecting from rear member 224 along the second direction, e.g., along the vertical direction V. Extension portion 288 extends between first side 206 and second side 208 along the lateral direction L. In some embodiments, however, extension portion 288 need not span the lateral length of powered shelf 200. Extension portion 288 includes a front surface 290 and an opposing rear surface 292. As shown, second electric coil 286 is attached to (e.g., printed on) extension portion 288 of rear member 224, and more particularly, second electric coil 286 is attached to rear surface 292 of extension portion 288. As shown in the depicted embodiment of FIG. 10, second electric coil 286 is printed on extension portion 288 substantially over the area of extension portion 288. However, in some embodiments, second electric coil 286 is printed on only a portion of the area of extension portion 288.

Second electric coil 286 is in electrical communication with a power source, such as e.g., the power source 145 of FIG. 3. For instance, electrical wires, power management device 270, powered track 150 (FIG. 3), as well as other electrical components may electrically couple second electric coil 286 with power source 145. In this way, when electric current is directed through second electric coil 286, a removably connected electrical device positioned on or proximate powered shelf 200 may be powered or charged by second electric coil 286. Thus, second electric coil 286 is configured to wirelessly provide electrical power to a removably connected electrical device placed on or proximate powered shelf 200.

Advantageously, by attaching second electric coil 286 along extension portion 288, which extends in a different plane than electric coil 280 attached to shelf panel 210, a removably connected electrical device may be powered or charged along a plane in the first direction by electric coil 280 (e.g., a direction orthogonal to the vertical direction V) and/or powered or charged along a plane in the second direction (e.g., along the vertical direction V) by second electric coil 286. Further, as second electric coil 286 is oriented in a plane along the second direction, e.g., the vertical direction V, removably connected electrical devices that have a mating coil that is positioned along the vertical height of the device may be powered or charged. Such a configuration may have other advantages not expressly listed herein. In addition, although extension portion 288 is shown projecting from rear member 224 in FIG. 10, in alternative exemplary embodiments, additionally or alternatively, extension portion 288 may project first side member 226 and/or second side member 228.

With reference again to FIG. 7, electrical power may be provided wirelessly to a removably connected electrical device in the following exemplary manner. First, a removably connected electrical device is placed on or proximate powered shelf 200. For instance, the removably connected electrical device may be placed on top surface 212 of shelf panel 210 or below powered shelf 200 on another shelf. Electric current is then directed from power source 145 to powered track 150 and ultimately to electric coil 280. In some embodiments, electric current may be continuously directed to electric coil 280 when powered shelf 200 is mounted to powered track 150. In yet other embodiments, electric current may be directed to electric coil 280 upon user activation. That is, a user may place an item on or proximate powered shelf 200 and then may activate or direct electric current through electric coil 280 to power or charge the removably connected electrical device. For instance, a user may manipulate one or more input selectors of user interface panel 136 to activate the current through electric coil 280. Once the powering option is selected on user interface panel 136, one or more signals indicative of the powering command may be sent to controller 134 (FIG. 1). Controller 134 may then send one or more signals to power management device 270 to instruct power management device 270 to allow an electric current flow through electric coil 280. In some embodiments, a user may activate the powering or charging of a removably connected electrical device via a user device communicatively coupled with controller 134 of refrigerator appliance 100. In yet further exemplary embodiments, electric current may be directed to electric coil 280 automatically. For instance, powered shelf 200 may sense that a new power-consuming device has been placed on powered shelf 200, and upon detection of the device, electric current may be directed to electric coil 280. In embodiments where a user activates electric current through electric coil 280 or automatically upon detection of a power-consuming electrical device, energy may be conserved when powering/charging functionality is not desired.

When electric current is directed through electric coil 280, the alternating electric current moving through electric coil 280 creates an alternating magnetic field. The alternating magnetic field in turn creates an alternating electric current in the secondary or device coil of the removably connected electrical device. The induced alternating electric current in the device coil can be used for useful work, such as e.g., powering the device or charging a battery. Accordingly, electric coil 280 is configured to wirelessly provide electrical power to the removably connected electrical device. It will be appreciated that second electric coil 286 may wirelessly provide electrical power to a removably connected electrical device in a similar manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An appliance, comprising:
a cabinet defining a volume;
a powered shelf in electrical communication with a power source for providing electrical power to a removably connected electrical device having a first power connection element and a second power connection element, the powered shelf comprising:
a frame having a first side member and a second side member spaced from the first side member, the first side member having a top surface and the second side member having a top surface;
a first electrical contact positioned along the top surface of the first side member, the first electrical contact in electrical communication with the power source;
a second electrical contact positioned along the top surface of the second side member, the second electrical contact in electrical communication with the power source, and
wherein when the first power connection element of the removably connected electrical device and the first electrical contact of the powered shelf are in contact and the second power connection element of the removably connected electrical device and the second electrical contact of the powered shelf are in contact, the powered shelf provides electrical power to the removably connected electrical device.

2. The appliance of claim 1, wherein the appliance defines a lateral direction and a transverse direction, and wherein the first side member and the second side member are spaced from one another along the lateral direction and the first electrical contact and the second electrical contact are aligned with one another along the transverse direction.

3. The appliance of claim 1, further comprising:
a shelf panel having a top surface and an opposing bottom surface, the frame extending about a perimeter of the shelf panel, and wherein the frame has a top surface that is flush with the top surface of the shelf panel.

4. The appliance of claim 1, wherein the frame comprises a front member, a rear member spaced from and opposing the front member, the first side member and the second side member extending between and connecting the front member with the rear member.

5. (canceled)

6. The appliance of claim 4, further comprising:
a third electrical contact positioned at the first side member.

7. The appliance of claim 4, further comprising:
a fourth electrical contact positioned at the rear member.

8. The appliance of claim 6, wherein the third electrical contact is a universal serial bus port.

9. The appliance of claim 1, wherein the appliance is a refrigerator appliance and the appliance further comprises:
a powered track mounted to the cabinet and in electrical communication with the power source, the powered shelf removably mounted to the powered track, and wherein when the powered shelf is mounted to the powered track, the powered track provides electrical communication between the power source and the powered shelf.

10. A powered shelf of an appliance for providing electrical power to a removably connected electrical device, wherein the powered shelf defines a vertical direction and a first direction orthogonal to the vertical direction, the powered shelf comprising:
a shelf panel;
an electric coil attached to or embedded within the shelf panel and in electrical communication with a power source, the electric coil configured to wirelessly provide electrical power to the removably connected electrical device;
a frame attached to the shelf panel, the frame having a top surface and an extension portion projecting upward from the frame along the vertical direction such that at least a portion of the extension portion is positioned above the shelf panel along the vertical direction;
a second electric coil attached to the portion of the extension portion that is positioned above the shelf panel along the vertical direction, the second electric coil in electrical communication with the power source and configured to wirelessly provide electrical power to the removably connected electrical device; and
at least two electrical leads in electrical communication with the power source, the at least two electrical leads being positioned along the top surface of the frame.

11. The powered shelf of claim 10, wherein the shelf panel has a top surface and an opposing bottom surface, and wherein the electric coil is attached to the bottom surface of the shelf panel.

12. The powered shelf of claim 10, further comprising:
a protective film, wherein the electric coil is disposed between the protective film and the shelf panel.

13. The powered shelf of claim 10, wherein the shelf panel defines an area, and wherein the electric coil is attached to the shelf panel substantially over the area of the shelf panel.

14. The powered shelf of claim 10, wherein the shelf panel extends between a front and a rear along the first direction, and wherein the frame has a rear member attached to the rear of the shelf panel, and wherein the extension portion projects upward from the rear member of the frame along the vertical direction.

15. The powered shelf of claim 14, wherein the extension portion has a front surface and an opposing rear surface, and wherein the second electric coil is attached to the rear surface of the extension portion.

16. The powered shelf of claim 10, wherein the shelf panel extends between a first side and a second side along a lateral direction perpendicular to the first direction and orthogonal to the vertical direction, and wherein the frame has a first side member attached to the first side of the shelf panel, and wherein the extension portion projects upward from the first side member of the frame along the vertical direction.

17. The powered shelf of claim 10, wherein the appliance is a refrigerator appliance.

18. The powered shelf of claim 10, wherein the frame extends about a perimeter of the shelf panel.

19. (canceled)

20. The powered shelf of claim 10, wherein the electric coil is embedded within the shelf panel.

21. (canceled)

22. The powered shelf of claim 10, further comprising:
a protective film; and
a spacer layer disposed between the protective film and the shelf panel, the spacer layer positioned only within a plane with the electric coil along the vertical direction.
